(19) United States
(12) Patent Application Publication
(10) Pub. No.: US 2011/0008120 A1
(43) Pub. Date: Jan. 13, 2011

(54) MILLING MACHINE FOR MILLING A SLAB

(76) Inventors: Matthias Kipping, Herdorf (DE); Juergen Merz, Kreuztal (DE); Juergen Seidel, Kreuztal (DE); Peter Sudau, Hilchenbach (DE); Frank Benfer, Bad Laasphe (DE)

Correspondence Address: ABELMAN, FRAYNE & SCHWAB, 666 THIRD AVENUE, 10TH FLOOR, NEW YORK, NY, 10017, US

(21) Appl. No.: 12/734,865

(22) PCT Filed: Nov. 24, 2008
(86) PCT No.: PCT/EP2008/009937

§ 371 Date: Sep. 7, 2010

(30) Foreign Application Priority Data
Nov. 29, 2007 (DE) 10 2007 057 423.3

(51) Int. Cl. B23C 3/13; B23Q 1/01; B23Q 11/00

(52) U.S. Cl. 409/135; 409/235; 409/230; 409/141; 409/159

(57) ABSTRACT

The invention relates to a milling machine (1) for milling at least one surface (2) of a slab (3), wherein the milling machine (1) is preferably a component of a device for producing a metal strip by continuous casting, wherein the milling machine (1) comprises a machine base (4) on which a spindle holder (5) is disposed and from which a spindle holder (5) is formed, in which at least one bearing (7) holding at least one milling cutter (6) is disposed. In order to achieve improved vibration damping during the milling of hot slabs, the invention makes provision such that the machine base (4) is formed at least in sections, preferably completely, from a number of metal walls (8) which enclose a volume, the volume being filled with concrete (9).

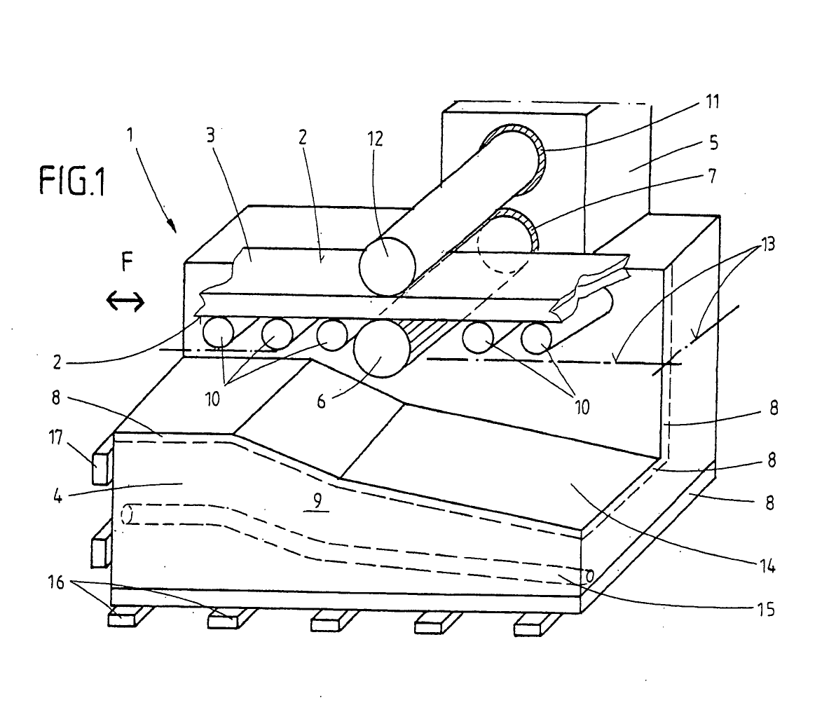

The invention relates to a milling machine for milling at least one surface of a slab, wherein the milling machine is preferably a component of a device for producing a metal strip by continuous casting, wherein the milling machine comprises a machine base on which a spindle holder is disposed and from which a spindle holder is formed, in which at least one bearing holding at least one milling cutter is disposed.

In the case of the continuous casting of slabs—they can be both thin slabs as well as thick slabs—in a continuous casting plant, surface defects can arise, such as for example oscillation markings, casting powder faults or longitudinally and transversely running surface cracks. The scaling following the casting also damages the slab surface. This occurs with conventional thin-slab casting machines.

If products with a high surface quality are to be produced, i.e. rolled, or if a crack-free or notch-free surface quality is required, slabs are usually flame-treated, i.e. the surface of the slab is burnt away with the aid of a gas-oxygen flame and ground by means of a special grinding machine.

Milling machines are known from nonferrous metal production (e.g. of copper alloys) which remove the oxide skin from printed circuit boards or coils by means of hob cutters.

The flame-treatment and grinding methods have their respective advantages and thus their justification for the given application. However, they also involve process drawbacks.

In the case of flame treatment, the surface of the slab is burnt away. During this process, considerable quantities of emissions (especially combustion gases and dust) are released. The combustion products cannot be readily introduced again into the by-product cycle.

Emissions which pollute the environment are also released with the grinding of slabs. These emissions often have to be conveyed through special extraction installations and filter systems in order to protect the environment against damage.

Limits are also imposed on the slab temperature at which the latter can be ground.

Milling machines, on the other hand, are able to process slabs at very high temperatures. They have virtually no emissions and the chips that arise can readily be introduced again into the by-product cycle.

The milling of slabs as such is prior art. Reference is made for example to DE 27 04 814 A1, to DE-AS 1 286 379, to DE-PS 838 105, to DE 696 34 103 T2, to DE 1 627 072 A1, to EP 0 705 653 B1, to DE-PS 335 136, to DE-PS 674 787 and to DE 197 17 200 A1.

With the milling of slabs, it has emerged that the work result is decisively dependent on whether and to what extent vibrations occur in the milling process. In particular, the milling of nonferrous metals is very sensitive with respect to occurring vibrations.

The excitation of vibrations arises due to the relatively large number of cutting edges, the shape of the cutting edge also having a not inconsiderable influence. It has therefore proved to be particularly important, precisely in the case of the milling of slabs, to ensure a low generation of vibrations during the milling process.

The problem underlying the present invention, therefore, is to develop a milling machine of the type mentioned at the outset in such a way that an improvement of the milling process becomes possible. In particular, it should be ensured that the development of vibrations in the milling machine is counteracted, so that overall a higher slab quality can be achieved.

The solution to this problem provided by the invention is characterised in that the machine base is formed at least in sections, preferably completely, from a number of metal walls which enclose a volume, the volume being filled with concrete.

The metal walls are preferably a component of a machine-base welded or cast construction. They can be made from normal structural steel or also stainless or acid-resistant steel.

The at least one milling cutter is preferably a plain-milling cutter, the axis of rotation whereof extends at right angles to the direction of motion of the slab. However, the use of a knife-head milling cutter is possible, the axis of rotation whereof is at right angles to the surface of the slab.

The bearing of at least one roller-table roller can be disposed beside the bearing for the milling cutter on or in the spindle holder. At least one guide rail for the slab can also be disposed beside the bearing for the milling cutter on the spindle holder. At least one bearing for a counter-hold roller can also be disposed beside the bearing for the milling cutter on the spindle holder.

The spindle holder can be disposed detachably on the machine base (e.g. connected to the latter by means of a screw connection). The spindle holder and the machine base can lie beside one another in a horizontal plane and be connected to one another.

The machine base can form an inclined surface in the region beneath the at least one milling cutter. This inclined surface can rise or fall in the conveying direction of the slab.

At least one pipe can be cast into the concrete. This pipe is preferably designed for the through-flow of a cooling medium.

At least one vibration-damping element can be disposed beneath and/or at the side of the machine base. The vibration-damping element can be embodied as a rail, which extends over the machine base at right angles to the conveying direction of the slab.

The vibration-damping element preferably has an adjustment function for adjusting the spacing between the machine base and the floor or a lateral stop face.

Finally, a development makes provision such that a slab transporting device is disposed in front of and/or behind the milling cutter in the conveying direction of the slab. Provision can be made such that the slab transporting device comprises at least one driven roller pair, which engages on the upper and lower side of the slab and exerts a conveying force on the slab. It is however also possible for the slab transporting device to comprise at least one driven roller pair which engages at the side edges of the slab and thus exerts a conveying force on the slab.

With the proposed solution, it is possible to stabilise the milling process in such a way that markedly fewer vibrations occur than with previously known plants. The result of the milling operation can thus be markedly improved and the quality of the surface processing of the slab can be enhanced.

This leads to qualitatively improved production of slabs, especially of thin slabs.

All the stated measures for damping the vibrations produce a longer service life of the milling cutters and an improved quality of the slab surface. The prefabrication, or more precisely the integration of the foundation into the machine, which accompanies the monolithic design, avoids extensive foundation work as well as assembly and erection work on site. Retrofitting can therefore be carried out very easily.

An example of embodiment of the invention is represented in the drawing. The single FIGURE shows in a perspective view a milling machine for the milling of a surface of a thin slab.

The FIGURE shows a milling machine 1, with which a surface 2 of a thin slab 3 can be milled away. In the present case, the underside of slab 3 is being worked by milling.

It should be noted that the front part of the machine, which is constructed as a mirror image of the rear part of the machine, is not represented in the FIGURE for reasons of clarity. The various components, such as milling cutters, roller-table rollers and counter-hold roller, are therefore not mounted overhung, but in the front machine part (not shown).

Milling machine 1 comprises a machine base 4, which carries a spindle holder 5. Spindle holder 5 can be designed in one piece with machine base 4 or also as a separate machine element which is connected to machine base 4. In the present case, spindle holder 5 is designed as a separate part, spindle holder 5 and machine base 4 lying beside one another in a horizontal plane 13. The parts are then rigidly connected with screws (not shown).

Located in spindle holder 5 is a bearing 7 for a milling cutter 6, which in the example of embodiment is designed as a plain-milling cutter, the axis of rotation whereof is orientated at right angles to conveying direction F of slab 3. Spindle holder 5 also comprises bearing 11 for a counter-hold roller 12 which, during the milling of slab 3, braces the latter on the side lying opposite milling cutter 6. Roller-table rollers 10 are also held by spindle holder 5, said roller-table rollers being required to hold and convey slab 3.

In order that the generation of vibrations is kept as low as possible during the milling process, provision is made such that machine base 4 is formed at least in sections—but completely in the example of embodiment—from a number of metal walls 8. In the example of embodiment, they are metal sheets which are cut to size and welded together in such a way that the desired external shape of machine base 4 results. Walls 8 enclose a hollow space which is filled by casting with concrete 9.

Walls 8 can of course also be produced in precisely the same way by a casting process.

In principle, cast-iron machine frames or machine beds have a relatively good damping behaviour. Compared to normal steel, grey cast iron has a two- to three-fold better damping behaviour. For concrete, the damping behaviour compared to grey cast iron can be exceeded at least by the factor 4, especially with suitable conditioning of the concrete.

With the proposed design, a monolithic type of construction emerges for machine base 4. The latter has good damping properties, especially if the concrete used is suitably conditioned, the modulus of elasticity and the vibration behaviour being adjustable. A reinforcement can also be provided specially tailored to the load to be expected.

Since the concrete also has a higher thermal capacity and a higher heat resistance, it is particularly well suited for the milling of hot slabs. For the casting of the concrete, the formwork, i.e. walls 8, can be made from normal steel or stainless and acid-resistant material.

Walls 8 can, as already mentioned, be processed by cutting and welding. As a consequence of this embodiment, there is the advantageous possibility of additional machine elements easily being able to be fitted and provided.

This also applies, for example, to an inclined surface 14, which can be used as a chip slide. The chips falling on inclined surface 14 can easily be conveyed away with a water jet.

Radiant heat, which concrete 9 must absorb due to hot slab 3, can be carried away by pipe 15 laid in concrete 9, said pipe being able to serve as a cooling pipe if cooling fluid flows through it. Pipe 15 can otherwise serve as an empty pipe for the current, water or lubricant supply.

Vibrations from the exterior, e.g. due to the finishing group of a hot strip mill and due to the vibration of the casting machine, on milling machine 1 are ineffective or at least greatly dampened by the monolithic design as well as the use of vibration-damping elements 16 and 17 as isolators and erection elements for the erection of milling machine 1.

In the example of embodiment, vibration-damping elements 16, 17 are disposed in such a way that they can take up vertical (see element 16) and horizontal (see element 17) forces.

The milling process preferably takes place in the hot state of slab 3. It takes place in or at right angles to conveying or feed direction F; plain-milling cutters are preferably used, although knife heads are also possible. The milling cutters preferably extend over the whole width of slab 3 to be milled.

The inventive proposal therefore focuses on the fact that milling machine 1 partially or completely comprises a machine frame which is produced from a composite material which comprises a steel construction (welded or cast construction) and concrete.

The machine construction is designed in such a way that a monolith arises through the combination of a steel or a cast-iron construction with concrete, so that it is possible to dispense with an individual machine foundation as such. The milling machine, or more precisely its machine base, can thus be set up directly on the floor of the hall, insofar as the latter can accommodate the occurring pressure per unit area.

The milling cutter or milling cutters, the roller-table rollers, the slab transporting devices and the guide units preferably form a unit with the concrete-filled machine base. It is however also possible for one or more, but not all, of the aforementioned elements to be connected to the concrete-filled machine base. Thus, guideways (guide beds) alone can have a keyed connection to the composite material of steel and concrete (see horizontal parting plane 13).

The following should be noted regarding the aforementioned slab transporting device. A slab transporting device (not represented in the FIGURE) has the task of driving or holding the slab against the milling force, so that cut-down milling or cut-up milling is possible.

The slab transporting device can be designed in such a way that a roller pair engages on the upper and lower side of the slab, said roller pair driving the slab. It is however also possible for the slab feed to take place via the side edges of the slab. Such a slab transporting or gripping device can be disposed in front of and/or behind the milling cutter and thus push and/or pull the slab, so that at least the milling forces and the frictional forces of the slab due to its weight are overcome.

Parting plane 13 is used for example if the milling machine is to be moved over a roadway, so that the foundation and the machine bed can be separated or are separated from the remaining machine.

### LIST OF REFERENCE NUMBERS

1 milling machine
2 surface of slab
3 slab
4 machine base
5 spindle holder
6 milling cutter
7 bearing
8 metal wall
9 concrete
10 roller-table roller
11 bearing
12 counter-hold roller
13 horizontal plane
14 inclined surface
15 pipe
16 vibration-damping element
17 vibration-damping element
F conveying direction of the slab

1. A milling machine (1) for milling at least one surface (2) of a slab (3), wherein the milling machine (1) is preferably a component of a device for producing a metal strip by continuous casting, wherein the milling machine (1) comprises a machine base (4) on which a spindle holder (5) is disposed and from which a spindle holder (5) is formed, in which at least one bearing (7) holding at least one milling cutter (6) is disposed,
characterized in that
the machine body (4) is formed at least in sections, preferably completely, from a number of metal walls (8) which enclose a volume, the volume being filled with concrete (9).

2. The milling machine according to claim 1,
characterized in that
the metal walls (8) are a component of a machine-base welded construction.

3. The milling machine according to claim 1,
characterized in that
the metal walls (8) are a component of a machine-base cast construction.

4. The milling machine according to claim 1,
characterized in that
the metal walls (8) are made from structural steel.

5. The milling machine according to claim 1,
characterized in that
the metal walls (8) are made from stainless steel.

6. The milling machine according to claim 1,
characterized in that
the metal walls (8) are made from acid-resistant steel.

7. The milling machine according to claim 1,
characterized in that
the at least one milling cutter (6) is a plain-milling cutter, the axis of rotation whereof extends at right angles to the direction of motion of the slab (3).

8. The milling machine according to claim 1,
characterized in that
the at least one milling cutter (6) is a knife-head milling cutter, the axis of rotation whereof is at right angles to the surface of the slab (3).

9. The milling machine according to claim 1,
characterized in that
the bearing of at least one roller-table roller (10) is disposed beside the bearing (7) for the milling cutter (6) on or in the spindle holder (5).

10. The milling machine according to claim 1,
characterized in that
at least one guide rail for the slab (3) is disposed beside the bearing (7) for the milling cutter (6) on the spindle holder (5).

11. The milling machine according to claim 1,
characterized in that
at least one bearing (11) for a counter-hold roller (12) is disposed beside the bearing (7) for the milling cutter (6) on the spindle holder (5).

12. The milling machine according to claim 1
characterized in that
the spindle holder (5) is disposed detachably on the machine base (4).

13. The milling machine according to claim 12,
characterized in that
the spindle holder (5) and the machine base (4) lie beside one another in a horizontal plane (13) and are connected to one another.

14. The milling machine according to claim 1,
characterized in that
the machine base (4) forms an inclined surface (14) in the region beneath the at least one milling cutter (6).

15. The milling machine according to claim 14,
characterized in that
the inclined surface (14) rises or falls in the conveying direction (F) of the slab (3).

16. The milling machine according to claim 1,
characterized in that
at least one pipe (15) is cast into the concrete (9).

17. The milling machine according to 16,
characterized in that
the pipe (15) is designed for the through-flow of a cooling medium.

18. The milling machine according to claim 1,
characterized in that
at least one vibration-damping element (16, 17) is disposed beneath and/or at the side of the machine base (4).

19. The milling machine according to claim 18,
characterized in that
the vibration-damping element (16, 17) is embodied as a rail, which extends over the machine base (4) at right angles to the direction of motion of the slab (3).

20. The milling machine according to claim 18,
characterized in that
at least one vibration-damping element (16, 17) has an adjustment function for adjusting the spacing between the machine base (4) and the floor or a lateral stop face.

21. The milling machine according to claim 1,
characterized in that
a slab transporting device is disposed in front of and/or behind the milling cutter (6) in the conveying direction (F) of the slab (3).

22. The milling machine according to claim 21,
characterized in that
the slab transporting device comprises at least one driven roller pair, which engages on the upper and lower side (2) of the slab and exerts a conveying force on the slab (3).

23. The milling machine according to claim 21,
characterized in that
the slab transporting device comprises at least one driven roller pair, which engages at the side edges of the slab (3) exerts a conveying force on the slab (3).
